(19) United States
(12) Patent Application Publication
(10) Pub. No.: US 2006/0145981 A1
(43) Pub. Date: Jul. 6, 2006

(54) Liquid crystal display and driving method thereof

(76) Inventors: Seung-Woo Lee, Seoul (KR); Young-Ki Kim, Kyungki-do (KR); Jung-Hee Lee, Kyungki-do (KR)

Correspondence Address: Hae-Chan Park;McGuireWoods, Suite 1800, 1750 Tysons Boulevard,, McLean, VA, 22102, US

(21) Appl. No.: 10/535,406

(22) PCT Filed: Nov. 20, 2003
(86) PCT No.: PCT/KR03/02514

§ 371 Date: Jan. 6, 2006

(30) Foreign Application Priority Data
Nov. 20, 2002 (KR) 10-2002-0072443

(51) Int. Cl. G09G 3/36

(52) U.S. Cl. 345/89

(57) ABSTRACT

A device of driving a liquid crystal display including a plurality of pixels connected to gate lines and data lines and arranged in a matrix is provided. The driving device includes: a gray voltage generator (800) generating a plurality of gray voltages; an image signal modifier (600) receiving first image signals for a pixel row and second image signals for a next pixel row, selecting modified image signal depending on the first image signals and the second image signals, and outputting the modified image signals; and a data driver (500) selecting data voltages from the gray voltages based on the modified image signals from the image signal modifier and applying the data voltages to the pixels.

### BACKGROUND OF THE INVENTION

(a) Field of the Invention

The present invention relates to a liquid crystal display and a driving method thereof.

(b) Description of the Related Art

Liquid crystal displays (LCDs) are the most commonly used one of flat panel displays (FPDs) handy to carry.

An LCD includes a pair of panels having field-generating electrodes and polarizers, and a liquid crystal (LC) layer with dielectric anisotropy, which is interposed between the panels and subject to electric field generated by the electrodes. The variation of the field strength changes molecular orientations of the LC layer, which tend to align parallel or perpendicular to the field direction. The LCD passes light through the LC layer via the polarizers and reorients the LC molecules to change the polarization of the light. The polarizers convert the change of the polarization into the change of the light transmittance and enable to obtain desired images.

The LCD has a narrow viewing angle. In particular, a twisted-nematic (TN) mode LCD having nematic LC with twisted alignment is widely used due to its many advantages, its application to monitors and television sets is limited due to its narrow viewing angle.

Several techniques such as multi-domains and compensation films for widening the viewing angle of the LCD are developed. In particular, compensation films often called wide viewing films give viewing characteristics in a lateral direction as good as other wide viewing techniques. However, gray inversion (that the brightness decreases as the gray voltage increases in a normally black mode LCD or vice versa in a normally white mode LCD) in a vertical direction still remains, which is severe particularly when viewing from the bottom.

Furthermore, a multi-domain LCD shows poor visibility at a lateral view compared with a normal TN mode LCD due to the inconsistency of gamma curves for a lateral view and for a front view. For example, a patterned-vertically-aligned (PVA) mode LCD having cutouts for forming domains displays brighter and whiter images as it goes away from the front to the lateral side. Sometimes, the brightness of the higher grays becomes indistinguishable to make the image mashed.

### SUMMARY OF THE INVENTION

A device of driving a liquid crystal display including a plurality of pixels connected to gate lines and data lines and arranged in a matrix is provided, which includes: a gray voltage generator generating a plurality of gray voltages; an image signal modifier receiving first image signals for a pixel row and second image signals for a next pixel row, selecting modified image signal depending on the first image signals and the second image signals, and outputting the modified image signals; and a data driver selecting data voltages from the gray voltages based on the modified image signals from the image signal modifier and applying the data voltages to the pixels.

The image signal modifier preferably includes a memory unit storing the image signals. The image signal modifier stores the first image signals into the memory unit, and reads out the first image signals stored in the memory unit and stores the second image signals into the memory unit upon receipt of the second image signals.

The memory unit may include a dual-port memory provided with a read port and a write port.

Preferably, the image signal modifier further includes a data modifier stores the modified image signals depending on the first image signals and the second image signals. The data modifier may include a look-up table.

The image signal modifier may further include a multiplexer for changing a path of the image signals supplied to the memory unit depending on the first image signals and the second image signals the memory unit The multiplexer changes the path in response to a control signal from an external device, and the control signal is synchronized with a horizontal synchronization signal and a data enable signal having a period equal to a transmission time of the image signals for a pixel row.

The memory unit may include a pair of single port memories reading and writing in turn.

Preferably, each pixel includes first and second subpixels, each subpixel includes a switching element connected to one of the gate lines and one of the data lines, and a pixel electrode connected to the switching element, and the first and the second subpixels are capacitively coupled with adjacent subpixels.

The pixels include upper and lower pixels adjacent to each other, the second pixel of the upper pixel is capacitively coupled with the first pixel of the lower pixel, a areal ratio of the pixel electrodes of the first subpixel and the second subpixel is defined to be equal to a:b, a data voltage (V₁′) corresponding to a modified image signal for the upper pixel is determined by:

$$\frac{aT ( {V}_{1} ) + bT ( {V}_{1} \pm 2 {CV}_{1} )}{a + b} = \frac{aT ( {V}_{1}^{′} ) + bT ( {V}_{1}^{′} + 2 {CV}_{2} )}{a + b} ,$$

where V₁ is a data voltage for an image signal for the upper pixel, V₂ is a data voltage for an image signal for the lower pixel, T(V) is transmittance for a voltage V, and C is a constant.

A method of driving a liquid crystal display including a plurality of gate lines, a plurality of data lines intersecting the gate lines, a plurality of switching elements connected to the gate lines and the data lines, and a plurality of pixel electrodes connected to the switching elements is provided, which includes: writing image data for a first pixel row into a memory; reading the image data for the first pixel row and writing image data for a second pixel row into the memory upon receipt of the image data for the second pixel row; selecting modified image signals determined by the image signals for the first and the second pixel rows; and applying the modified image signals to the pixels through the switching elements.

### BRIEF DESCRIPTION OF THE DRAWINGS

The present invention will become more apparent by describing embodiments thereof in detail with reference to the accompanying drawings in which:

FIG. 1 is a block diagram of an LCD according to an embodiment of the present invention;

FIG. 2A is an equivalent circuit diagram of an LCD according to an embodiment of the present invention;

FIG. 2B is an equivalent circuit diagram of an LCD according to another embodiment of the present invention;

FIG. 3 is an equivalent circuit diagram of a pixel of an LCD according to an embodiment of the present invention;

FIG. 4 is a layout view of a TFT array panel for an LCD according to an embodiment of the present invention;

FIGS. 5A and 5B are sectional views of the TFT array panel shown in FIG. 4 taken along the lines VA-VA′ and VB-VB′, respectively;

FIG. 6 is a graph illustrating voltage-transmission (V-T) curves of an LCD according to an embodiment of the present invention;

FIG. 7 is a block diagram of a pixel voltage modifier according to an embodiment of the present invention;

FIG. 8 is an exemplary look-up table of a pixel voltage modifier according to an embodiment of the present invention; and

FIG. 9 is a block diagram of a pixel voltage modifier according to another embodiment of the present invention.

### DETAILED DESCRIPTION OF PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, film, region, substrate or panel is referred to as being “on” another element, it can be directly on the other element or intervening elements may also be present. In contrast, when an element is referred to as being “directly on” another element, there are no intervening elements present.

Then, liquid crystal displays and driving methods thereof according to embodiments of the present invention will be described with reference to the drawings.

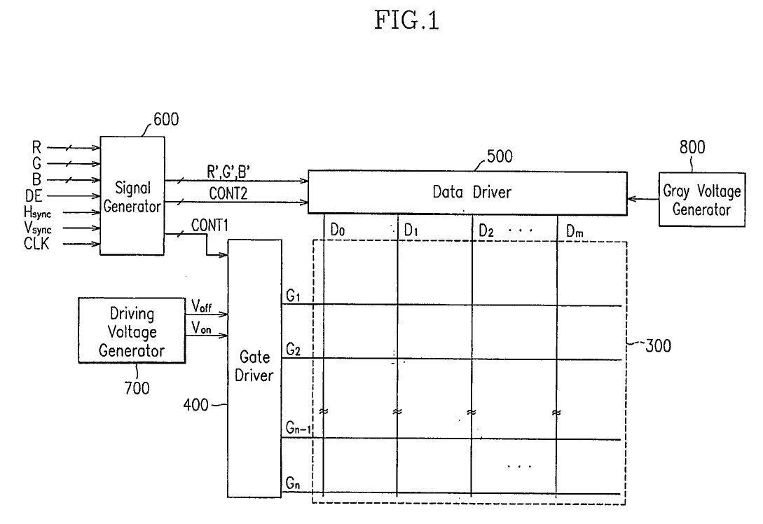

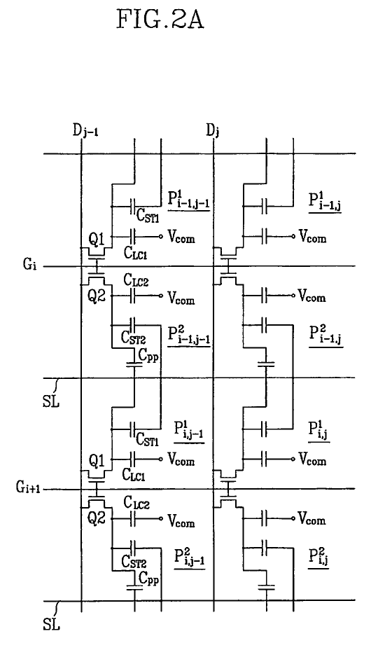

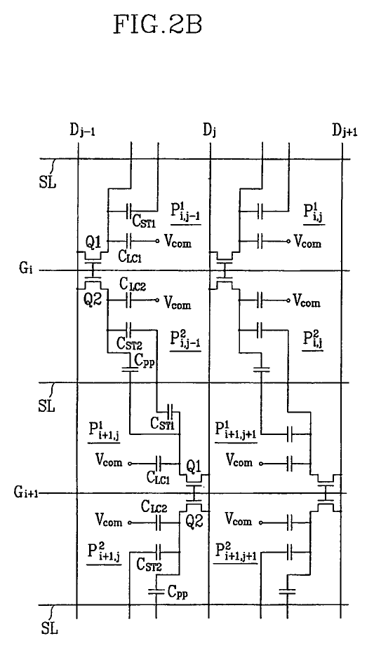

FIG. 1 is a block diagram of an LCD according to an embodiment of the present invention, FIG. 2A is an equivalent circuit diagram of a liquid crystal panel assembly of an LCD according to an embodiment of the present invention, FIG. 2B is an equivalent circuit diagram of a liquid crystal panel assembly of an LCD according to another embodiment of the present invention, and FIG. 3 is an equivalent circuit diagram of a subpixel of an LCD according to an embodiment of the present.

Referring to FIG. 1, an LCD according to an embodiment includes an LC panel assembly 300, a gate driver 400 and a data driver 500 which are connected to the panel assembly 300, a driving voltage generator 700 connected to the gate driver 400, a gray voltage generator 800 connected to the data driver 500, and a signal controller 600 controlling the above elements.

In circuital view shown in FIGS. 1, 2A and 2B, the panel assembly 300 includes a plurality of display signal lines G₁-G_{N}, D₁-Dₘ and SL and a plurality of pixels connected thereto and arranged substantially in a matrix.

The display signal lines include a plurality of gate lines G₁-Gₙ transmitting gate signals (called scanning signals) and a plurality of data lines D₁-Dₘ transmitting data signals. The gate lines G₁-Gₙ extend substantially in a row direction and are substantially parallel to each other, and the data lines D₁-Dₘ extend substantially in a column direction and are substantially parallel to each other.

The display signal lines further includes a plurality of storage electrode lines SL located between the gate lines G₁-Gₙ and between the pixels and supplied with a predetermined voltage such as a common voltage Vcom. The storage electrode lines SL are located between the gate lines G₁-Gₙ and between the pixels, extend substantially in a row direction, and are substantially parallel to each other. The storage electrode lines SL may be omitted.

Each pixel is defined by a gate line and a data line. For example, a pixel (i, j) (i=1, 2, . . . , n and j=1, 2, . . . , m) represented by Pᵢⱼ means a pixel connected to an i-th gate line Gᵢ and a j-th data line Dⱼ.

Referring to FIGS. 2A and 2B, each pixel Pᵢⱼ includes a pair of subpixels P_{i,j}¹ and P_{i,j}², and each subpixel P_{i,j}¹ or P_{i,j}² includes a switching element Q1 or Q2 connected to a pair of an appropriate gate line Gᵢ and an appropriate data line Dⱼ, and an LC capacitor C_{LC1} or C_{LC2} and a storage capacitor C_{ST1} or C_{ST2} that are connected to the switching element Q1 or Q2. The storage capacitor C_{ST1} and C_{ST2} may be omitted, and the storage electrode lines SL are not required in this case.

The switching element Q1 or Q2 such as a thin film transistor (TFT) has three terminals: a control terminal connected to one of the gate lines G₁-Gₙ; an input terminal connected to one of the data lines D₁-Dₘ; and an output terminal connected to the LC capacitor C_{LC1} or C_{LC2} and the storage capacitor C_{ST1} or C_{ST2}.

The LC capacitor C_{LC1} or C_{LC2} is connected between the switching element Q1 or Q2 and the common voltage Vcom, while the storage capacitor C_{ST1} or C_{ST2} is connected between the switching element Q1 or Q2 and the storage electrode line SL. In the absence of the storage electrode lines SL, the storage capacitor C_{ST1} or C_{ST2} is connected to an adjacent gate line.

In planar view, a subpixel is assigned to an area surrounded by a pair of a gate line and a storage electrode line SL adjacent to each other and a pair of adjacent data lines, and the subpixels are arranged in a matrix. In other words, either a gate line or a storage electrode line SL is located between a pair of adjacent subpixel rows, and a data line is located between a pair of adjacent subpixel columns. Since the number of the subpixel columns is equal to the number of the pixel columns, the terms “subpixel column” and “pixel column” are used in the same meaning. It is noted that the number of the subpixel rows are twice the number of the pixel rows.

The subpixels P_{i,j}¹ and P_{i,j}² of each pixel Pᵢⱼ are located opposite each other with respect to a gate line Gi connected thereto. All subpixels in each subpixel row are connected to a gate line, and all the subpixels in a pair of subpixel rows located opposite with respect to an arbitrary gate line are connected to the gate line. For example, the subpixels in a pair of subpixel rows adjacent to the i-th gate line Gi is connected to the i-th gate line Gi. Accordingly, an i-th pixel row is defined as both subpixel rows connected to the i-th gate line Gi.

On the contrary, the subpixels P_{i,j}¹ and P_{i,j}², of each pixel Pᵢⱼ are located at the same side with respect to a data line Dj connected thereto. All subpixels of the pixels connected to a gate line are located at the same side with respect to the respective data lines.

FIG. 2A shows an arrangement that all the subpixels of the pixels connected to a data line are located at the same side with respect to the data line. Although the subpixels shown in FIG. 2A are located at the right side of the data line connected thereto, they may be located at the left side thereof.

FIG. 2B shows an arrangement that some of the subpixels of the pixels connected to a data line are located at one side with respect to the data line, while the others of the subpixels are located at the opposite side. In other words, some of the subpixels in a subpixel row are connected to a left data line, while the others of the subpixels are connected to a right data line.

As shown in FIG. 2B, relative positions of the pixels with respect to a data line connected thereto are alternated. For example, subpixels P_{i,j}¹ and P_{i,j}² of a pixel Pᵢⱼ among the pixels connected to the j-th data line D) are located at the right side of the data line Dj, while subpixels P_{i+1,j}¹ and P_{i+1,j}² of a pixel P_{i+1,j} connected to the j-th data line Dj are located at the left side of the data line D.

According to another embodiment of the present invention, relative positions of the pixels with respect to a data line connected thereto are alternated in unit of two or more pixels.

An upper subpixel P_{i,j}¹ and a lower subpixel P_{i,j}² of a pixel Pᵢⱼ are capacitively coupled with subpixels in subpixel rows adjacent thereto along the column direction by a coupling capacitor Cpp. FIGS. 2A and 2B show that each subpixel in a pixel column is coupled with a subpixel adjacent thereto in the pixel column. For example, the upper subpixel P_{i,j}¹ of the pixel Pᵢⱼ is capacitively coupled with a lower subpixel P_{i-1,j}² of an upper pixel P_{i'1,j}, and a lower subpixel P_{i,j}² of a pixel Pᵢⱼ is capacitively coupled with an upper subpixel P_{i+1,j}¹ of a lower pixel P_{i+1,j}. The above-described capacitive coupling between the subpixels in the same pixel column is referred to as “internal column coupling.”

According to another embodiment of the present invention, the pixels in different subpixel columns are capacitively coupled, which is referred to as “inter-column coupling.”

Meanwhile, FIG. 3 schematically shows a structure of a liquid crystal panel assembly 300 according to an embodiment of the present invention. For descriptive convenience, only a subpixel is illustrated in FIG. 3.

As shown in FIG. 3, a liquid crystal panel assembly 300 includes a lower panel 100, an upper panel 200 opposite the lower panel 100, and a liquid crystal layer 3 interposed therebetween. Gate lines Gᵢ and Gᵢ₋₁, a data line Dⱼ, a switching element Q, and a storage capacitor Cₛₜ are provided on the lower panel 100. A pixel electrode 190 on the lower panel 100 and a common electrode 270 on the upper panel 200 form two terminals of a liquid crystal capacitor C_{lc}. The liquid crystal layer 3 disposed between the two electrodes 190 and 270 functions as dielectric of the liquid crystal capacitor C_{lc}.

The pixel electrode 190 is connected to the switching element Q and the common electrode 270 is connected to the common voltage V_{com} and covers entire surface of the upper panel 200.

The orientations of liquid crystal molecules in the liquid crystal layer 3 are changed by the alteration of electric field generated by the pixel electrode 190 and the common electrode 270. The change of the molecular orientations varies the polarization of light passing through the liquid crystal layer 3, which in turn causes the variation of the transmittance of the light by a polarizer or polarizers (not shown) attached to at least one of the panels 100 and 200.

The pixel electrode 190 overlaps a storage electrode line SL to form a storage capacitor C_{ST}, and it is capacitively coupled with adjacent pixel electrode by a coupling capacitor Cpp. The pixel electrode 190 and/or the common electrode 270 may have a plurality of cutouts or a plurality of protrusions formed thereon for increasing viewing angle.

FIG. 3 shows a MOS transistor as a switching element, and the MOS transistor is implemented as a thin film transistor including an amorphous silicon or polysilicon channel layer in a practical manufacturing process. Accordingly, the lower panel 100 is also referred to as “TFT array panel.”

Different from FIG. 2, the common electrode 270 may be provided on the lower panel 100. In this case, both the electrodes 190 and 270 have shapes of stripes or bars.

For realizing color display, each pixel can represent a color by providing one of a plurality of red, green and blue color filters 230 in an area corresponding to the pixel electrode 190. The color filter 230 shown in FIG. 3 is provided in the corresponding area of the upper panel 200, which is also referred to as “color filter array panel.” Alternatively, the color filter 230 is provided on or under the pixel electrode 190 on the lower panel 100.

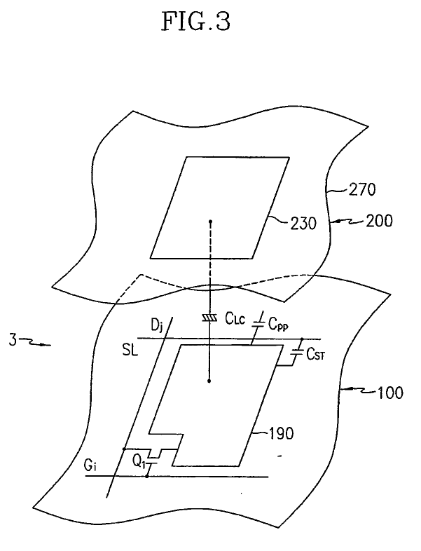

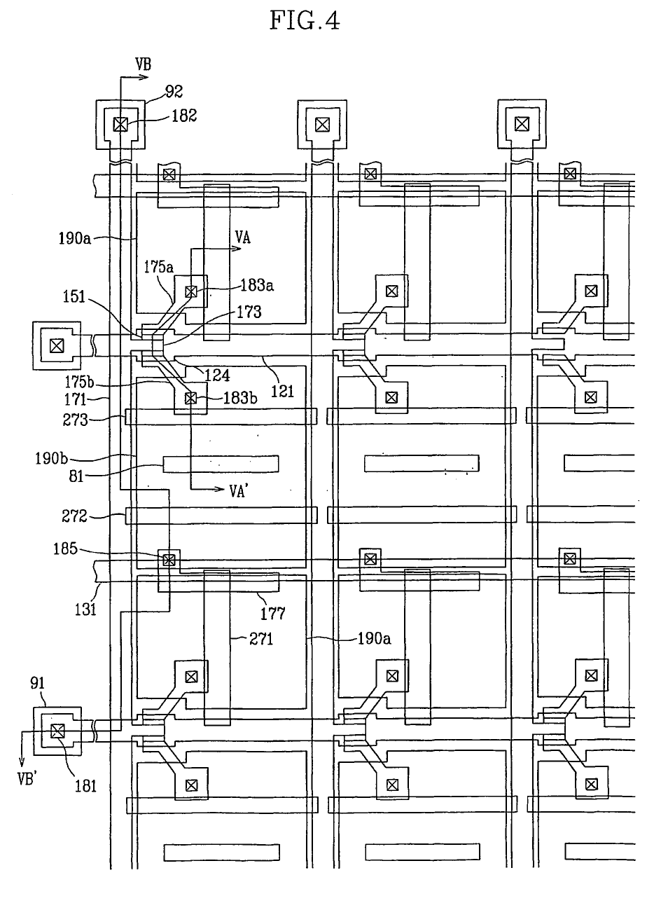

Now, an LC panel assembly of an LCD according to an embodiment of the present invention is described in detail with reference to FIGS. 4 to 5B.

FIG. 4 is a layout view of a TFT array panel for an LCD according to an embodiment of the present invention, and FIGS. 5A and 5B are sectional views of the TFT array panel shown in FIG. 4 taken along the lines VA-VA′ and VB-VB′, respectively.

An LCD according to this embodiment also includes a TFT array panel 100, a color filter panel 200, and an LC layer 3 interposed therebetween.

A TFT array panel 100 includes a plurality of gate lines 121 and a plurality of storage electrode lines 131 are formed on an insulating substrate 110 preferably made of transparent glass. Each gate line 121 extends substantially in a row direction and includes a plurality of expansions forming gate electrodes 124. Each storage electrode line 131 extends substantially parallel to the gate lines and may include a plurality of branches.

The gate lines 121 and the storage electrode lines 131 is preferably made of Al containing metal such as Al and Al alloy, Ag containing metal such as Ag and Ag alloy, Mo containing metal such as Mo and Mo alloy, Cr, Ti, or Ta. They may include two films having different physical characteristics, a lower film and an upper film. The upper film is preferably made of low resistivity metal including Al containing metal and Ag containing metal for reducing signal delay or voltage drop in the gate lines 121 and the storage electrode lines 131. On the other hand, the lower film is preferably made of material such as Ti, Ta, Cr, Mo and Mo alloy having good electrical, physical and chemical contact characteristics with other materials such as ITO (indium tin oxide) or IZO (indium zinc oxide). A good exemplary combination of the lower film material and the upper film material is Cr and Al—Nd alloy.

The lateral sides of the gate lines 121 and the storage electrodes 131 are tapered, and the inclination angle of the lateral sides with respect to a surface of the substrate 110 ranges about 30-80 degrees.

A gate insulating layer 140 preferably made of silicon nitride (SiNx) is formed on the gate lines 121 and the storage electrode lines 131.

A plurality of semiconductor stripes and islands 151 and 157 preferably made of hydrogenated amorphous silicon (abbreviated to a-Si) are formed on the gate insulating layer 140. Each semiconductor stripe 151 extends substantially in a column direction and includes a plurality of projections branched out toward the gate electrodes 124. Each projection includes a central portion 153, a pair of channel portions 154a and 154b located opposite each other with respect to the central portion 153, and a pair of outer portions 155a and 155b connected to the respective channel portions 154a and 154b.

A plurality of ohmic contact stripes and islands 161, 165a, 165b and 167 preferably made of silicide or n+hydrogenated a-Si heavily doped with n type impurity such as P are formed on the semiconductor stripes and islands 151 and 157.

The lateral sides of the semiconductor stripes and islands 151 and 157 and the ohmic contacts 161, 165 a, 165b and 167 are tapered, and the inclination angles thereof are preferably in a range between about 30-80 degrees.

A plurality of data lines 171, a plurality of pairs of drain electrodes 175a and 175b, and a plurality of coupling electrodes 177 are formed on the ohmic contact stripes and islands 161, 165a, 165b and 167, respectively.

Each data line 171 extends in the column direction along the semiconductor stripe 151 and includes a plurality of source electrodes 173 branched therefrom and located on the gate electrodes 124. The drain electrodes 175a and 175b are located opposite each other with respect to the source electrodes 173 and extend upward and downward from the gate electrodes 124.

A gate electrode 124, a source electrode 173, and a drain electrode 175a and 175b along with a channel portion 154a or 154b form a TFT.

Each coupling electrode 177 extends substantially in the row direction and partly overlaps the storage electrode line 131.

The data lines 171, the drain electrodes 175a and 175b, and the coupling electrodes 177 include a conductive film preferably made of Al containing metal, Ag containing metal, Mo containing metal such as Mo and Mo alloy, Cr, Ti, or Ta. However, they may have a multi-layered structure.

Like the gate lines 121, the data lines 171, the drain electrodes 175a and 175b, and the coupling electrodes 177 have tapered lateral sides, and the inclination angles thereof range about 30-80 degrees.

The ohmic contacts 163, 165a, 165b and 167 are disposed only between the semiconductor stripes and islands 151 and 154 and the data lines 171, the drain electrodes 175a and 175b, and the coupling electrodes 177 overlying thereon.

The semiconductor stripes and islands 151 and 157 have almost the same planar shapes as the data lines 171, the drain electrodes 175a and 175b, and the coupling electrodes 177 as well as the underlying ohmic contacts 161, 165a, 165b and 167, except for the channel portions 154a and 154b, which are not covered with the data lines 171, the drain electrodes 175 and the storage conductors 177. In particular, the semiconductor islands 157, the ohmic contact islands 167 and the coupling electrodes 177 have substantially the same planar shape.

The semiconductor stripes and islands 151 and 157 may have a shape different from the data lines 171, the drain electrodes 175a and 175b, and the coupling electrodes 177. For example, the semiconductor stripes 151 may be removed except for the channel portions 154a and 154b. The width of each semiconductor stripe 151 may become large near the intersections of the gate lines 121 and the data lines 171 for enhancing insulation therebetween.

A passivation layer 180 preferably made of silicon nitride or organic insulator is formed on the data lines 171, the drain electrodes 175a and 175b, the coupling electrodes 177 and the channel portions 154a and 154b of the semiconductor stripes 151.

The passivation layer 180 is provided with a plurality of contact holes 183a, 183b and 185 respectively exposing end portions of the drain electrodes 175a and 175b and the coupling electrodes 177, and a plurality of contact holes 182 exposing end portions of the data lines 171. The gate insulating layer 140 and the passivation layer 180 are provided with a plurality of contact holes 181 exposing end portions of the gate lines 121.

A plurality of pairs of pixel electrodes 190a and 190b and a plurality of contact assistants 91 and 92 are formed on the passivation layer 180. The pixel electrodes 190a and 190b and the contact assistants 91 and 92 are preferably made of a transparent conductive material such as indium-tin-oxide (ITO) and indium-zinc-oxide (IZO) or a reflective material.

Each pair of pixel electrodes 190a and 190b includes an upper pixel electrode 190a and a lower pixel electrode 190b connected to the drain electrodes 175a and 175b through the contact holes 183a and 183b, respectively. The lower electrode 190b is connected to the coupling electrode 177 through the contact hole 185 and the upper electrode 190a overlaps the coupling electrode 177 such that the lower pixel electrode 190b of an upper pixel and the upper pixel electrode 190a of a lower pixel are capacitively coupled. In addition, the lower pixel electrode 190b of an upper pixel and the upper pixel electrode 190a of a lower pixel are located opposite across the storage electrodes line 131 and overlap the storage electrode line 131 to form a plurality of storage capacitors.

Each lower pixel electrode 190b has a linear cutout 81 extending substantially in the row direction, and it may further have at least one additional cutout extending in the row direction. Each upper pixel electrode 190a may have at least one cutout extending in the column direction. It is preferable that an area occupied by the upper pixel electrode 190a is equal to about 10 to 50 percents, more preferably, about 20 to 30 percents of the total area of the upper and the lower pixel electrodes 190a and 190b.

The contact assistants 91 and 92 are connected to the exposed end portions of the gate lines 121 and the data lines 171 through the contact holes 181 and 182, respectively. The contact assistants 91 and 92 are optionally provided for protecting the exposed portions and for complementing the adhesiveness of the exposed portions and external devices.

An alignment layer 11 is coated on the entire surface of the TFT array panel 100 except for areas including the contact assistants 91 and 92. Referring to FIGS. 4 and 5A, the color filter array panel 200 includes a black matrix 220 formed on an insulating substrate 210 preferably made of transparent glass. The black matrix 220 defines a plurality of windows where a plurality of red, green and blue color filters 230 are formed. An overcoat 250 is formed on the color filters 230 and a common electrode 270 preferably made of a transparent conductive material such as ITO and IZO is formed thereon.

The common electrode 270 has a plurality of sets of three cutouts 271-273. A set of cutouts include a longitudinal cutout 271 extending substantially in the column direction and two transverse cutouts 272 and 273 extending substantially in the row direction. The longitudinal cutout 271 bisects the upper pixel electrode 190a into left and right subareas, and the transverse cutouts 272 and 273 are located opposite with respect to the cutout 81 of the lower pixel electrode 190b. The cutouts 272, 81 and 273 quarter the lower pixel electrode 190b into four quarter subareas arranged in the column direction. Each subarea formed by a set of cutouts 81 and 271-273 has a shape of rectangle having two long edges parallel to the gate lines 121 or the data lines 171.

The cutout 81 of the upper pixel electrode 190a and the cutouts of the lower pixel electrodes 190b may exchange their positions. That is, the transverse cutout 81 may be provided in the lower pixel electrode 190b, while the longitudinal cutouts 271-273 are provided in the upper pixel electrode 190a.

An alignment layer 21 is formed on the common electrode 270.

A pair of polarizers 12 and 22 are attached to outer surfaces of the panels 100 and 200, respectively. The polarization axes of the polarizers 12 and 22 are crossed and substantially parallel to the gate lines 121 or the data lines 171.

The molecules of the LC layer 3 are aligned such that their major axes are substantially parallel to or perpendicular to the surfaces of the panels 100 and 200 in absence of electric field. The homeotropic (i.e., vertical) alignment is preferred for wide viewing angle.

At least one of the cutouts 81 and 271-173 may be substituted with at least one protrusions formed on the passivation layer 180.

The coupling electrodes 177 may be formed on the gate lines 121 and, in this case, they are carefully designed not to meet the storage electrode lines 131.

Referring back to FIG. 1, the driving voltage generator 700 generates a gate-on voltage Vₒₙ for turning on the switching elements Q1 and Q2 and a gate-off voltage V_{off} for turning off the switching elements Q1 and Q2.

The gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom.

The gate driver 400 often called a scanning driver is connected to the gate lines G₁-Gₙ of the panel assembly 300 and applies gate signals to the gate lines G₁-Gₙ. Each gate signal is a combination of the gate-on voltage Vₒₙ and the gate-off voltage V_{off} provided from the driving voltage generator 700.

The data driver 500 often called a source driver is connected to the data lines D₁-Dₘ of the panel assembly 300 and applies data voltages selected from the gray voltages from the gray voltage generator 800 to the data lines D₁-Dₘ.

The signal controller 600 controls the gate driver 400 and the data driver 500, etc.

Now, the operation of the LCD will be described in detail.

The signal controller 600 is supplied with RGB image signals R, G and B and input control signals controlling the display thereof such as a vertical synchronization signal V_{sync}, a horizontal synchronization signal H_{sync}, a main clock CLK, and a data enable signal DE, from an external graphic controller (not shown). After generating gate control signals CONT1 and data control signals CONT2 and processing the image signals R, G and B to be suitable for the panel assembly 300 on the basis of the input control signals and the input image data R, G and B, the signal controller 600 provides the gate control signals CONT1 for the gate driver 400, and the processed image signals R′, G′ and B′ and the data control signals CONT2 for the data driver 500.

The gate control signals CONT1 include a vertical synchronization start signal STV for informing of start of a frame, a gate dock signal CPV for controlling the output time of the gate-on voltage Vₒₙ, and an output enable signal OE for defining the duration of the gate-on voltage Vₒₙ. The data control signals CONT2 include a horizontal synchronization start signal STH for informing of start of a horizontal period, a load signal LOAD for instructing to apply the data voltages to the data lines D₁-Dₘ, an inversion control signal RVS for reversing the polarity of the data voltages (with respect to the common voltage Vcom), and a data clock signal HCLK.

The data driver 500 receives a packet of the image data R′, G′ and B′ for a pixel row from the signal controller 600, converts the image data R′, G′ and B′ into the analog data voltages selected from the gray voltages supplied from the gray voltage generator 800, and applies the data voltages to the data lines D₁-Dₘ in response to the data control signals CONT2 from the signal controller 600.

Responsive to the gate control signals CONT1 from the signals controller 600, the gate driver 400 applies the gate-on voltage Vₒₙ to a gate line G₁-Gₙ, thereby turning on the switching elements Q1 and Q2 connected thereto.

Then, the data voltages are supplied to the corresponding pixels via the activated switching elements Q1 and Q2.

The difference between the data voltage and the common voltage Vcom applied to a pixel is expressed as a charged voltage of the LC capacitor C_{LC1} or C_{LC2}, i.e., a pixel voltage. The liquid crystal molecules have orientations depending on the magnitude of the pixel voltage, which determine the polarization of light passing through the LC capacitor C_{LC1} or C_{LC2}. The polarizers 11 and 21 convert the light polarization into the light transmittance.

After finishing scanning on a pixel row for one horizontal period (“1H”), which is equal to one period of the horizontal synchronization signal H_{sync}, the data enable signal DE, and the gate clock signal CPV), a next pixel row is scanned. By repeating this procedure, all gate lines G₁-Gₙ are sequentially supplied with the gate-on voltage Vₒₙ during a frame, thereby applying the data voltages to all pixels. When the next frame starts after finishing one frame, the inversion control signal RVS applied to the data driver 500 is controlled such that the polarity of the data voltages is reversed (which is called “frame inversion”). The inversion control signal RVS may be also controlled such that the polarity of the data voltages flowing in a data line in one frame are reversed (which is called “line inversion”), or the polarity of the data voltages in one packet are reversed (which is called “dot inversion”).

In the meantime, the difference between a data voltage for a pixel P_{i,j} and the common voltage Vcom, which is also referred to as “the data voltage” by assuming the common voltage Vcom equal to zero for descriptive convenience, is represented as dⱼⁱ, and the voltages charged in the LC capacitors C_{LC1} and C_{LC2} of the upper and the lower subpixels P_{i,j}¹ and P_{i,j}² of the pixel P_{i,j}, which are referred to as “pixel voltages,” are represented as V(P_{i,j}¹) and V(P_{i,j}²), respectively. The pixel voltages V(P_{i,j}¹) and V(P_{i,j}²) are given by:

$$\begin{matrix}V ( {P}_{i , j}^{1} ) = {d}_{j}^{i} , and & ( 1 ) \\ V ( {P}_{i , j}^{2} ) = {d}_{j}^{i} + \frac{( {d}_{j}^{i + 1} - {d}_{j}^{′ i + 1} ) {C}_{pp}}{{C}_{LC 2} + {C}_{ST 2} + {C}_{pp}} = {d}_{j}^{i} + C \cdot Δ {d}_{j}^{i + 1} , \\ where \\ C = \frac{{C}_{pp}}{{C}_{LC 2} + {C}_{ST 2} + {C}_{pp}} and Δ {d}_{j}^{i + 1} = {d}_{j}^{i + 1} - {d}_{j}^{′ i + 1} . & ( 2 )\end{matrix}$$

In Relations 1 and 2, C_{LC2} and C_{ST2} represent the capacitances of the LC capacitor and the storage capacitor of the lower subpixel P_{i,j}², respectively, Cₚₚ indicates the capacitance of the coupling capacitor, and d′ⱼⁱ⁺¹ indicates the data voltage applied to the subpixel P_{i+1,j}¹ in a previous frame. For descriptive convenience, wire resistance and signal delay of the data lines D₁-Dₘ are ignored.

Since dⱼⁱ⁺¹ and d′ⱼⁱ⁺¹ indicates have different polarity,
|Δdⱼⁱ⁺¹|≧|dⱼⁱ⁻¹|≧0, and
|Δdⱼⁱ⁺¹|≧d′ⱼⁱ⁺¹|≧0 (3)

Since Δdⱼⁱ⁺¹ has the same polarity as dⱼⁱ when dⱼⁱ⁺¹ and dⱼⁱ have the same polarity,
|V(P_{i,j}²)|=|dⱼⁱ+C·Δdⱼⁱ⁺¹|≧|dⱼⁱ|=|V(P_{i,j}¹|. (4)

In case that dⱼⁱ⁺¹ and dⱼⁱ have the opposite polarity as in dot inversion or line inversion, since Δdⱼⁱ⁺¹ and dⱼⁱ have the opposite polarity, that is, since −Δdⱼⁱ⁺¹ has the same polarity as dⱼⁱ,
|V(P_{i,j}²)|=|dⱼⁱ−C·(−Δdⱼⁱ⁺¹)|≦|dⱼⁱ|=|V(P_{i,j}¹|. (5)

According to Relations 4 and 5, the lower subpixel is charged with a voltage higher than that charged in the upper subpixel if two capacitively coupled subpixels by a coupling capacitor have the same polarity, and vice versa.

As a result, when the data voltages applied to adjacent two pixel rows have the same polarity, a lower subpixel of an upper pixel is charged with increased voltage, while the lower subpixel of the upper pixel is charged with decreased voltage when the data voltages applied to adjacent two pixel rows have the opposite polarity. Accordingly, the voltages charged in an upper subpixel and in a lower subpixel of a pixel are different.

In the meantime, the pixel voltage charged in the lower subpixel p_{i,j}² of the pixel P_{i,j} depends on the magnitude of the difference in the data voltages for a lower pixel P_{i,j+1} between a previous frame and a current frame as shown in FIG. 2.

Let us consider a still image for easy explanation. For a still image, the absolute value of the data voltage in the previous frame is the same as that in the current frame. In consideration of frame inversion, since d′ⱼⁱ⁺¹=−dⱼⁱ⁺¹,
V(P_{i,j}²)=dⱼⁱ+2C·dⱼⁱ⁺¹. (6)

From Relation 6, it can be seen that the pixel voltages of pixels in a pixel row depend on the data voltages applied to a next pixel row even though the pixels are supplied with the same data voltage.

In particular, the deviation of the pixel voltages in the upper pixel row is large when the deviation of the pixel voltages in the lower pixel row is large.

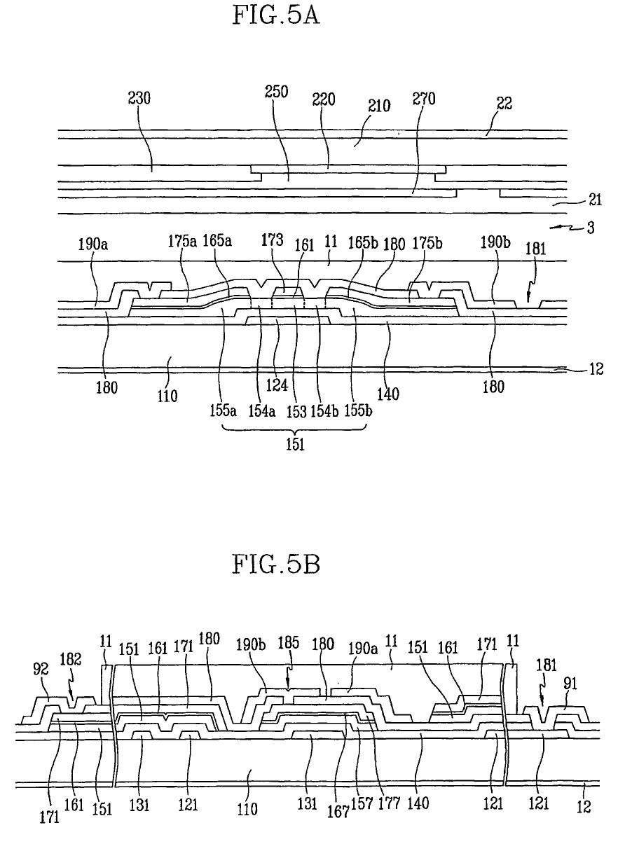

Meanwhile, the transmittance of a subpixel having a pixel voltage V is indicated by T(V). T(V) may be different product by product and exhibits the characteristic shown in FIG. 6 for a normally black mode LCD. It is assumed that the ratio of the area between an upper pixel and a lower pixel of each pixel is equal to a:b.

The luminance Tᵢⱼ of the pixel P_{i,j} is given by:

$${T}_{ij} = \frac{aT [ V ( {P}_{i , j}^{1} ) ] + bT [ V ( {P}_{i , j}^{2} ) ]}{a + b} . \qquad ( 7 )$$

From Relation 1 and 6,

$${T}_{ij} = \frac{aT ( {d}_{j}^{i} ) + bT ( {d}_{j}^{i} + 2 C \cdot {d}_{j}^{i + 1} )}{a + b} . \qquad ( 8 )$$

It can be seen from Relation 8 that the transmittance of the pixels in an upper pixel row have significant deviation when the data voltages for the pixel in a lower pixel row are much different.

The present embodiment modifies image data of a pixel such that the transmittance of the pixel supplied with a data voltage equal to a data voltage applied to a lower pixel is equal to that supplied with a data voltage different from the data voltage applied to the lower pixel.

For example, a still image is considered.

In case that a j-th pixel in an i-th pixel row is supplied with the same data voltage as the lower pixel, dot inversion makes the polarity of the upper and the lower pixels opposite such that dⱼⁱ=−dⱼⁱ⁺¹, while dⱼⁱ=dⱼⁱ⁺¹ if the polarity of the upper and the lower pixels are the same. Accordingly,

$${T}_{ij} = \frac{aT ( {d}_{j}^{i} ) + bT ( {d}_{j}^{i} \pm 2 C \cdot {d}_{j}^{i} )}{a + b} . \qquad ( 9 )$$

After removing the subscript j, a modified voltage of the data voltage dⁱ is indicated by d_{c}ⁱ. Then, the transmittance Ti after modification is given by:

$${T}_{i} = \frac{aT ( {d}_{c}^{i} ) + bT ( {d}_{c}^{i} + 2 C \cdot {d}^{i + 1} )}{a + b} . \qquad ( 10 )$$

From Relations 9 and 10,

$$\frac{aT ( {d}^{i} ) + bT ( {d}^{i} \pm 2 C \cdot {d}^{i} )}{a + b} = \frac{aT ( {d}_{c}^{i} ) + bT ( {d}_{c}^{i} + 2 C \cdot {d}^{i + 1} )}{a + b} \qquad ( 11 )$$

Since the voltage-transmittance (V-T) characteristic is predetermined, the modified data voltage d_{c}ⁱ for a pixel is obtained from the data voltage dⁱ for the pixel and the data voltage dⁱ⁺¹ for the lower pixel by using Relation 11. It is apparent that it can be applied to motion images under the assumption that the data voltages in the current frame and the previous frame are the same.

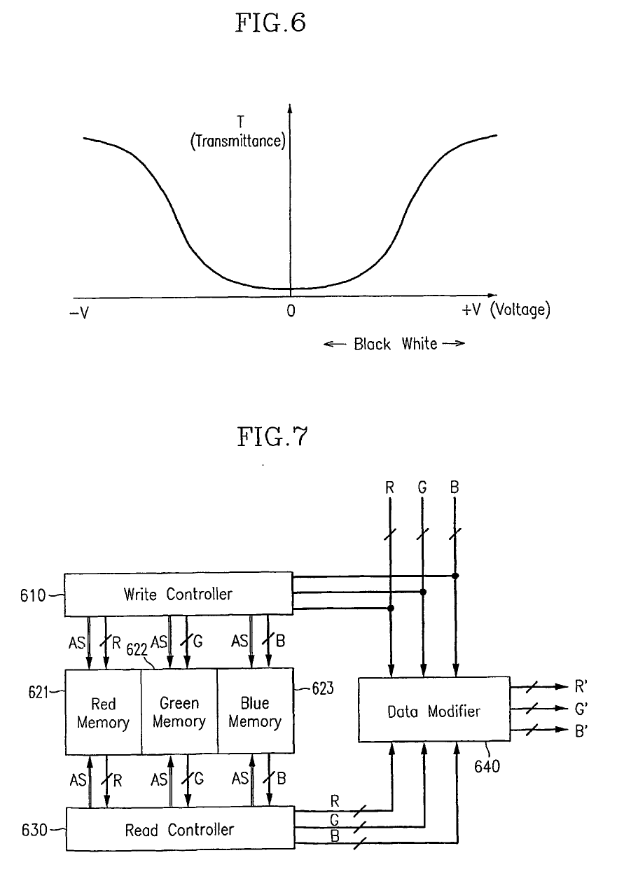

An exemplary configuration for the above-described operation is described in detail with reference to FIG. 7.

FIG. 7 is a block diagram of a pixel voltage modifier according to an embodiment of the present invention.

As shown in FIG. 7, a pixel voltage modifier according to an embodiment of the present invention includes red, green and blue memories 621-623 storing image data R, G and B for a pixel row, a memory write controller 610 and the memory read controller 630 connected to the memories 621-623, and a data modifier 640 receiving the image data the image data R, G and B and connected to the memory read controller 630.

Each memory 621-623, which is a dual port memory capable of simultaneous reading and writing, has an address terminal and a data terminal connected to the memory write controller 610 and the memory read controller 630, respectively and stores the image data R, G and B for a pixel row.

The memory write controller 610 receives the image data R, G and B and writes the received image data R, G and B into the memories 621-623.

The memory read controller 630 read out the image data R, G and B from the memories 621-623 and outputs the read image data R, G and B to the data modifier 640.

The data modifier 640 compares the image data R, G and B from the memory read controller 630 with currently inputting image data R, G and B, and retrieves modified image data R′, G′ and B′ from a look-up table storing the modified image data R′, G′ and B′ determined by the above-described scheme. The data modifier provides the modified image data R′, G′ and B′ for the data driver 500.

The pixel voltage modifier may be incorporated into a signal controller 600 or may be stand-alone.

The operation of the pixel voltage modifier will be described in detail.

First, after the image data R, G and B from an external device are inputted into the memory write controller 610 and the data modifier 640, the memory write controller 610 writes the image data R, G and B into the memories 621-623. The write operation is performed in a way that the memory write controller 610 provides the image data R, G and B for the memories 621-623 through the data terminal and applies an address signal AS for informing of the writing locations through the address terminal to the memories 621-623.

After the image data R, G and B for a pixel row are stored in the memories 621-623, the memory read controller 630 reads out the image data R, G and B stored in the memories 621-623 and supplies the read image data R, G and B to the data modifier 640 as previous image data. The read operation is performed in a way that the memory read controller 630 applies an address signal AS for informing of the reading positions through the address terminal to the memories 621-623 and the memories 621-623 supplies the image data R, G and B stored in the reading positions to the memory read controller 630 through the data terminal.

At this time, the data modifier 640 receives image data for a next pixel row (referred to as “current image data”) from an external device. The data modifier 640 compares the previous image data from the memory read controller 630 with the current image data, selects modified image data determined by the previous and the current image data from the look-up table, and outputs the selected image data to the data driver 500 as the modified image data R′, G′ and B′ of the previous image data.

Detailed steps are described now.

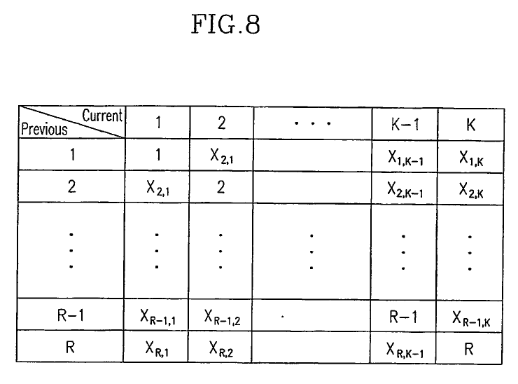

After the previous image data and the current image data are compared, the previous image data are outputted as the modified image data R′, G′ and B′ when the previous data and the current data are equal or their difference is equal to or lower than a predetermined value. When the two data are different or their difference is larger than the predetermined value, a modified image data in the look-up table is selected to be output An example of the look-up table is shown in FIG. 8. Here, X_{i,j} is obtained from Relation 11.

While the memory read controller 630 reads out the previous image data from the memories 621-623, the memory write controller 610 writes the current image data into the memories 621-623. The write operation and the read operation are simultaneously performed or the write operation follows the read operation.

In the meantinme, since there is no image data stored in the memories 621-623 when the image data R, G and B for the first pixel row is inputted into the data modifier 640, there is no output from the data modifier 640. Since the image data for the first pixel row is outputted from the data modifier 640 when the image data for the second pixel row is inputted, the input time of the image data R, G and B precedes the output time of the modified image data R′, G′ and B′ by a horizontal period or a period of a horizontal synchronization H_{sync}.

As describe above, the present embodiment generates a modified image data from a current image data and a previous image data to be outputted to the data driver such that it compensates the luminance difference between the pixels in a row due to the gray difference between upper pixels and lower pixels.

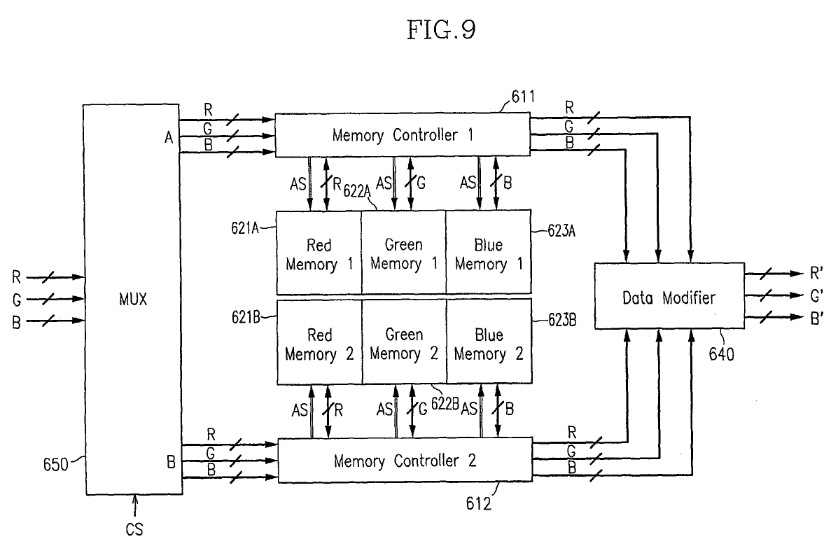

Next, a pixel voltage modifier according to another embodiment of the present invention is described in detail with reference to FIG. 9.

FIG. 9 is a circuit diagram of a pixel voltage modifier according to another embodiment of the present invention.

The pixel voltage generator according to this embodiment is distinguished from the pixel voltage modifier shown in FIG. 7 in that it employs single port memories, which cannot simultaneously read and write. In detail, the pixel voltage modifier shown in FIG. 9 includes the multiplexer 650 receiving the image data R, G and B, a pair of first and second memory controllers 611 and 612 connected to output terminals of the multiplexer 650, a pair of first and second red memories 621A and 621B, a pair of first and second green memories 622A and 622B and a pair of the first and the second blue memories 623A and 623B connected to the first and the second memory controllers 611 and 612 through the address terminal and the data terminal, and the data modifier 640 connected to the first and the second memory controllers. 611 and 612.

The multiplexer 650 determines output path of a signal in response to a control signal CS applied to a control terminal. The control signal CS has a high state and a low state and is made by a signal controller 600 in synchronization with a signal such as a horizontal synchronization signal H_{sync} and a data enable signal DE having a period equal to a transmission time of the image data for a pixel row. For example, when the control signal CS is in the high state, the output path of the multiplexer 650 is a first path A, while the output path is a second path B when the control signal CS is in the low state. However, the relation between the output path of the multiplexer 650 and the state of the control signal CS can be altered.

An operation of the data voltage modifier according to an embodiment of the present invention is now described in detail.

First, when the image data R, G and B are inputted, the output path of the multiplexer 650 for the image data is the first path A if the control signal CS is in the high state. Therefore, the multiplexer 650 transmits the image data R, G and B to the first memory controller 611. The first memory controller 611 transmits the image data R, G and B to the data modifier 640 and outputs address signals AS along with the image data R, G and B to the first memories 621A, 622A and 623A to store the image data R, G and B.

After all the image data R, G and B for a pixel row are inputted, the control signal CS becomes low and the output path of the multiplexer 650 is moved into the second path B. The multiplexer 650 transmits the image data R, G and B for the next row to the second memory controller 612 through the second path B. The second memory controller 612 supplies the image data R, G and B to the data modifier 640 as the current image data, and it provides the image data R, G and B along with the address signal AS for the second memory controller 612 to store the image data R, G and B into the memories 621B, 622B and 623B. At the same time, the first memory controller 611 reads out the image data R, G and B from the memories 621A, 622A and 623A to be supplied for the data modifier 640 as the previous image data.

The data modifier 640 compares the previous image data with the current image data and selects and outputs modified image data R′, G′ and B′ depending on the current image data and the previous image data.

As describe above, the present embodiment generates a modified image data from a current image data and a previous image data to be outputted to the data driver such that it compensates the luminance difference between the pixels in a row due to the gray difference between upper pixels and lower pixels. This scheme is particularly useful for an LCD having capacitively coupled pixels.

What is claimed is:

1. A device of driving a liquid crystal display including a plurality of pixels connected to gate lines and data lines and arranged in a matrix, the device comprising:
a gray voltage generator generating a plurality of gray voltages;
an image signal modifier receiving first image signals for a pixel row and second image signals for a next pixel row, selecting modified image signal depending on the first image signals and the second image signals, and outputting the modified image signals; and
a data driver selecting data voltages from the gray voltages based on the modified image signals from the image signal modifier and applying the data voltages to the pixels.

2. The device of claim 1, wherein the image signal modifier comprises a memory unit storing the image signals.

3. The device of claim 2, wherein the image signal modifier stores the first image signals into the memory unit, and reads out the first image signals stored in the memory unit and stores the second image signals into the memory unit upon receipt of the second image signals.

4. The device of claim 3, wherein the memory unit includes a dual-port memory provided with a read port and a write port.

5. The device of claim 2, wherein the image signal modifier further comprises a data modifier stores the modified image signals depending on the first image signals and the second image signals.

6. The device of claim 5, wherein the data modifier comprises a look-up table.

7. The device of claim 2, wherein the image signal modifier further comprises a multiplexer for changing a path of the image signals supplied to the memory unit depending on the first image signals and the second image signals the memory unit.

8. The device of claim 7, wherein the multiplexer changes the path in response to a control signal from an external device, and the control signal is synchronized with a horizontal synchronization signal and a data enable signal having a period equal to a transmission time of the image signals for a pixel row.

9. The device of claim 7, wherein the memory unit comprises a pair of single port memories reading and writing in turn.

10. The device of claim 1, wherein each pixel includes first and second subpixels, each subpixel includes a switching element connected to one of the gate lines and one of the data lines, and a pixel electrode connected to the switching element, and the first and the second subpixels are capacitively coupled with adjacent subpixels.

11. The device of claim 10, wherein the pixels include upper and lower pixels adjacent to each other, the second pixel of the upper pixel is capacitively coupled with the first pixel of the lower pixel, a areal ratio of the pixel electrodes of the first subpixel and the second subpixel is defined to be equal to a:b, a data voltage (V₁′) corresponding to a modified image signal for the upper pixel is determined by:
$$\frac{aT ( {V}_{1} ) + bT ( {V}_{1} \pm 2 {CV}_{1} )}{a + b} = \frac{aT ( {V}_{1}^{′} ) + bT ( {V}_{1}^{′} + 2 {CV}_{2} )}{a + b} ,$$
where V₁ is a data voltage for an image signal for the upper pixel, V₂ is a data voltage for an image signal for the lower pixel, T(V) is transmittance for a voltage V, and C is a constant.

12. A method of driving a liquid crystal display including a plurality of gate lines, a plurality of data lines intersecting the gate lines, a plurality of switching elements connected to the gate lines and the data lines, and a plurality of pixel electrodes connected to the switching elements, the method comprising:
writing image data for a first pixel row into a memory;
reading the image data for the first pixel row and writing image data for a second pixel row into the memory upon receipt of the image data for the second pixel row;
selecting modified image signals determined by the image signals for the first and the second pixel rows; and
applying the modified image signals to the pixels through the switching elements.
